(19) United States
(12) Patent Application Publication
(10) Pub. No.: US 2011/0041922 A1
(43) Pub. Date: Feb. 24, 2011

(54) CONTROLLED LIQUID HANDLING

(75) Inventor: Tomas Ussing, Frederiksberg (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: FLUIMEDIX APS, Taastrup (DK)

(21) Appl. No.: 12/921,996

(22) PCT Filed: Mar. 11, 2009
(86) PCT No.: PCT/DK2009/000063

§ 371 Date: Nov. 3, 2010

(30) Foreign Application Priority Data
Mar. 12, 2008 (DK) PA 2008 00383

(51) Int. Cl. F15D 1/00

(52) U.S. Cl. 137/13; 137/1

(57) ABSTRACT

The present invention relates to methods, devices and apparatuses for performing controlled liquid handling, and particularly, for performing controlled liquid handling in micro conduit systems. The invention involves pressing the liquid to be controlled against an enclosed gas to pressurize the gas, and controlling the flow of the liquid by controlling the subsequent evacuation of the pressurized gas. The present invention may be use for liquid handling in chemical and biomedical analysis systems.

### FIELD OF THE INVENTION

The present invention relates to methods, devices and apparatuses for performing controlled liquid handling, and particularly, for performing controlled liquid handling in micro conduit systems. The invention involves pressing the liquid to be controlled against an enclosed gas to pressurize the gas, and controlling the flow of the liquid by controlling the subsequent evacuation of the pressurized gas.

### BACKGROUND

A basic challenge when designing and operating liquid-containing micro conduit systems is interfacing the micro conduit system to macroscale equipment, such as pumps and valves, and to control and time the internal liquid flows of the micro conduit system remotely by means of the external equipment. Macroscale pumps, although readily available, are not suited for propelling microscale liquid volumes in a micro conduit system. One solution to this challenge is to integrate micro pumps into the micro conduit system and to control the liquid flow by controlling the integrated pumps. Alternatively, capillary forces, that are predominant in the microscale, may be used to propel the liquid. Yet an alternative is to drive and control the liquid by means of centrifugal forces by spinning the micro conduit system and to control the liquid flow by controlling the spinning speed.

### SUMMARY OF THE INVENTION

The present inventor has realized that the prior art has failed to provide simple and reliable methods and devices enabling precisely controlled liquid handling in micro conduit systems, and he has sought to solve this problem.

Thus, an object of the invention is to provide methods, devices and apparatuses that allow for precisely controlled liquid handling.

Yet an object of the invention is to provide methods, devices and apparatuses that are simple to manufacture and which preferably can be produced at a low cost.

A further object of the invention is to provide methods, devices and apparatuses that are easy to operate and that provide reliable results.

Additional objects and advantages of the invention are described below.

A broad aspect of the invention relates to a method of controlling a liquid flow, i.e. starting the flow of the liquid, controlling the flow rate, and/or stopping the flow. The method typically comprises the steps of:
a) providing a device comprising a micro conduit system, the micro conduit system comprising
   at least one inlet,
   a conduit section containing a first liquid, and
   a closed conduit section adjoining the conduit section, said closed conduit section containing a gas, said gas contacting the first liquid of the conduit section, and
b) providing a liquid driving system pressing the first liquid against the gas, thus pressurizing the gas, and
c) activating an evacuation mechanism, thereby allowing at least a portion of the pressurized gas of the closed conduit section to evacuate, and thereby allowing the liquid driving system to introduce the first liquid into the closed conduit section.

The method is illustrated in FIGS. 1A-C. A simple embodiment of the device (1) is shown in FIG. 1A. The device (1) contains a base portion (2) containing a micro conduit system (4) partially closed by a lid (3) thus making up a wall section, and additionally containing an inlet (5) allowing liquid to access to the enclosed part of the micro conduit system (4). In FIG. 1B a first liquid, represented as the hatching, has been applied to the inlet (5) and has been introduced into a conduit section of the micro conduit system due to capillary forces between the first liquid and the micro conduit system, i.e. the capillary forces act as liquid driving system. The capillary forces act on the first liquid, pressing it against the gas enclosed in the closed conduit section of the micro conduit system. Once a pressure equilibrium has been reached the flow of the first liquid stops. In FIG. 1C the evacuation mechanism has been activated by pressing a pointed object (6) against the lid (2), thereby creating a hole (11) which allows the pressurized gas of the closed conduit section to evacuate. Once the gas starts evacuating, the first liquid flows into the closed conduit section.

An advantage of the present invention is that it allows for the movement of precise liquid volumes at selected and controlled points in time without the hysteresis introduced by external driving or activation equipment. Additionally, while many prior art lab-on-a-chip tend to be very complex to produce and operate, the present invention has the virtues of simplicity and robustness.

### BRIEF DESCRIPTION OF THE FIGURES

In the following, some of the embodiments of the present invention will be described with reference to the figures, wherein

FIG. 1A-C illustrate the method of the invention using a simple device,

FIG. 2A-B illustrate the use of a device comprising a second closed conduit section forming a sub-part of a first closed conduit section,

FIG. 3 illustrates a device comprising a bifurcated micro conduit system,

FIGS. 4A-B illustrate devices wherein the evacuation is obtained using a laser for burning a hole in a wall section of the closed conduit section,

FIGS. 5A-B illustrate a device comprising a removable seal,

FIG. 6 illustrates a device wherein the micro conduit system comprises a gas retarding element, and

FIG. 7 illustrates a device comprising a PCR analysis system.

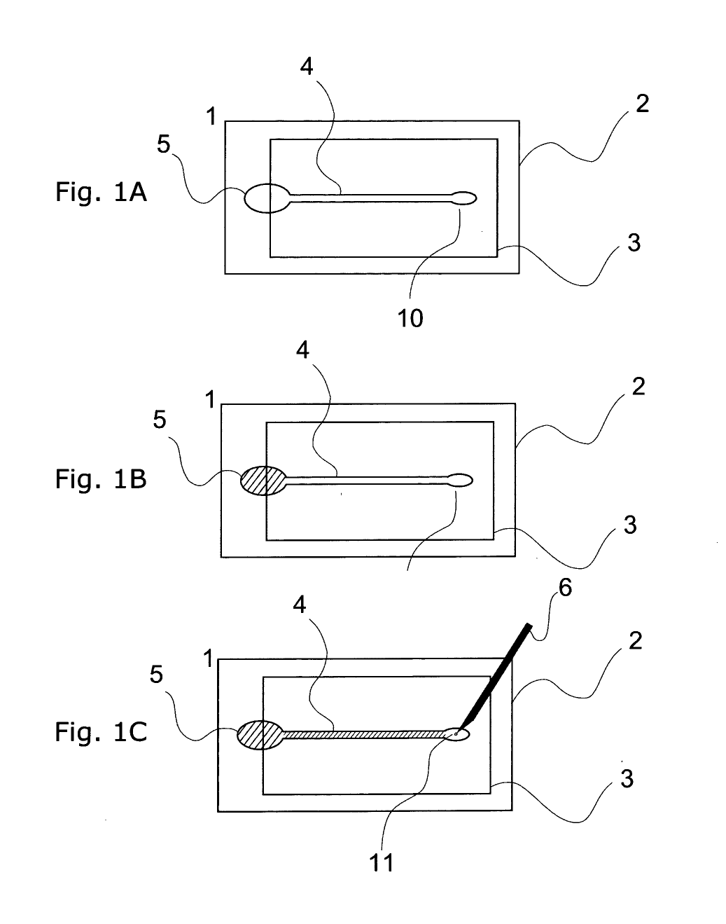

### DETAILED DESCRIPTION OF THE INVENTION

A broad aspect of the invention relates to a method of controlling a liquid flow. The method typically comprises the steps of:
a) providing a device comprising a micro conduit system, the micro conduit system comprising
   at least one inlet,
   a conduit section containing a first liquid, and
   a closed conduit section adjoining the conduit section, said closed conduit section containing a gas, said gas contacting the first liquid of the conduit section, and
b) providing a liquid driving system pressing the first liquid against the gas, thus pressurizing the gas, and
c) activating an evacuation mechanism, thereby allowing at least a portion of the pressurized gas of the closed conduit section to evacuate, and thereby allowing the liquid driving system to introduce the first liquid into the closed conduit section.

In the context of the present invention the term “device” relates to the object in which the flow of the liquid is controlled. The device may be a so-called microfluidic system, a micro-TAS (micro-total analysis) device, a lab-on-a-chip device, or a biochip device. Such a device can be produced in multitude of different materials such as silicon, glass, ceramics and/or organic polymers, such as moldable polymer.

The device may be prepared in many different ways using conventional microtechniques such as micro-fabrication, micro-milling, injection molding, hot embossing, and laser machining. The device may be implemented as a highly complex, multilayered structure or as a simple structure comprising few layers. Relatively simple devices comprising as few device parts as possible are presently preferred. The device parts are the parts of which the device is assembled, and in some preferred embodiments of the invention, the device parts comprise a lid and a base portion. The base portion typically comprises a surface into which the micro conduit system has been imprinted or otherwise created, and onto which surface the lid has to be attached to complete the micro conduit system. In this case, the walls of the micro conduit system are partly or completely formed by the base portion and the lid.

In some embodiments of the invention the first liquid of step a) is provided by applying said first liquid to the inlet and moving it to the conduit section using the liquid driving system. The term “moving” both encompasses both movement resulting from active liquid driving systems such as a pump, and movement resulting from passive liquid driving systems, such as movement due to capillary forces between the first liquid and the micro conduit system.

In step b) the gas is pressurizing, and therefore its pressure is typically higher than the surrounding atmospheric pressure.

In the context of the present invention, the term “evacuating” or “evacuate” relates to gas molecules leaving the closed conduit section. The net effect of the evacuation is that the pressure of the pressurized gas is, at least temporarily, reduced and the first liquid is allowed to enter the closed conduit section.

A number of evacuation mechanisms may be used according to the present invention. In some preferred embodiments of the invention activating the evacuation mechanism comprises creating a hole in a wall section of the closed conduit section, said hole allowing at least a portion of the pressurized gas to leave the closed conduit section.

For example, the hole may be created by heating a portion of said wall section. The heating should cause burning and/or melting of at least a part of said wall section and thereby creating the hole. An advantage of this type of evacuation mechanism is that the hole normally may be created at any location at a given wall section, and does not require incorporation of micro valves or other complex micro-mechanical components.

The heating may at least partly be provided by a heating element, such as a resistive or an inductive heating element. Useful examples of resistive heating elements are an electrode or a conducting or semi-conducting layer.

The heating may also comprise absorption of electromagnetic radiation by said wall section or by a part of the device adjacent to said wall section.

Electromagnetic radiation as a source of heating may advantageously be used as it does not require incorporation of heating elements in the device and therefore offers a larger degree of freedom when designing and producing the device. Additionally, the use of electromagnetic radiation for heating results in simpler, cheaper, more robust, and more reliable methods and devices.

In some embodiments of the invention, the hole is created by ablating a portion of said wall section using electromagnetic radiation.

A preferred source of electromagnetic radiation is a laser, and preferably a diode laser. Normally, the wavelength of the electromagnetic radiation is selected so that substantial absorption of the radiation occurs within a spatially limited volume of the device. Presently, it is preferred to use a diode laser having a peak wavelength intensity in the range of 750-850 nm, such as in the range or 805-815 nm.

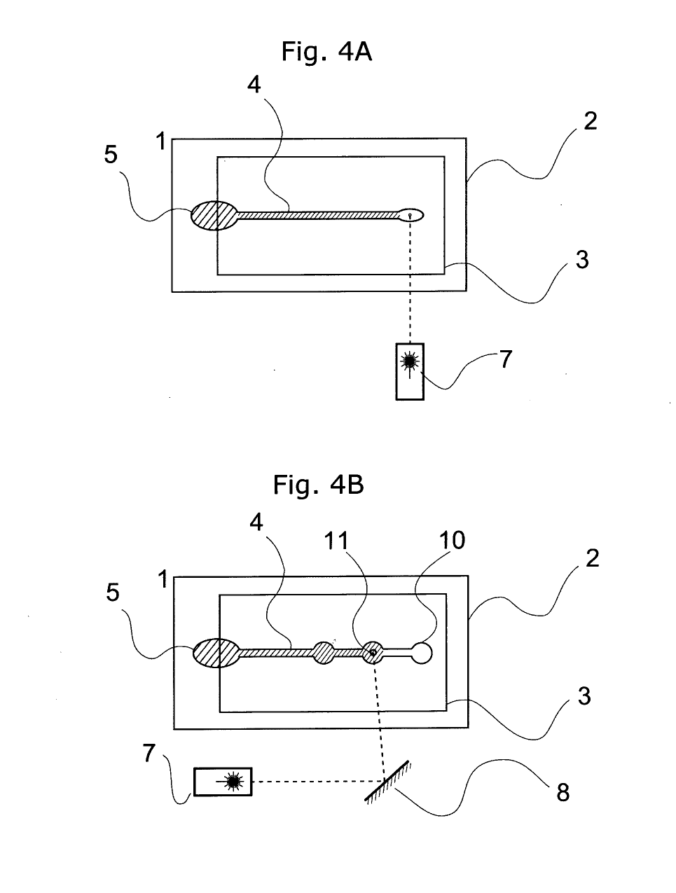

Exemplary embodiments of the invention are shown in FIGS. 4A-B. FIG. 4A shows a device (1) as previously described, wherein a laser beam from a laser (7) is directed towards a wall section of the device (1), which wall section melts to form a through-going hole (11) to the closed conduit section and thus allows pressurized gas to evacuate. FIG. 4B additionally shows a mirror scanning device (8), which controls which position of the device that the laser beam addresses. An advantage of using a mirror scanning device (8) is that it allows for addressing multiple points or areas of the device in sequence using the same laser source. The liquid driving system of the device in FIGS. 4A-B is capillary forces between the first liquid and the micro conduit system.

In some preferred embodiments of the invention, the device comprises a radiation absorber, and at least a portion of the electromagnetic radiation is absorbed by said radiation absorber. The radiation absorber converts a substantial amount of radiation into heat in a relatively small volume of material, thus enabling rapid heating, melting, or ablation. Another advantage of using the radiation absorber is that the other materials of the device, e.g. the materials of the base portion or the lid, need not absorb any of the electromagnetic radiation and can therefore be chosen from a larger group of materials than if high absorption was a key requirement.

The radiation absorber may be present as a layer which has been applied to a portion of the device, typically located adjacent to or inside the micro conduit system. Alternatively, or additionally, the radiation absorber may be mixed with some of the bulk material of which the device is produced.

Useful radiation absorbers typically exhibit a very high absorption of the electromagnetic radiation used in some embodiments of the method, and may e.g. comprise one or more components selected from the group consisting of a dye, a nanoparticle, and a paints.

A number of useful radiation absorber are commercially available, e.g. from Epolin (NY, US) or Avecia (US, JP). For example, Pro-jet 830 NP from Avecia has been used successfully with an IR diode laser.

The radiation absorber may be located several places within or outside the device. For example, the wall section to be burnt/melted/ablated may comprise the radiation absorber. Alternatively or additionally, the radiation absorber may be located adjacent to the wall section, preferably in a sufficiently short distance from the wall section to obtain melting or burning by a part of said wall section. The radiation absorber may be located inside and/or outside the closed conduit section. For example, the radiation absorber may be located on or in a second wall section of the closed conduit section, which second wall section opposes the wall section in which the hole is to be created.

The device may comprise a translucent device section located adjacent to the radiation absorber, said device section allowing the electromagnetic radiation to reach the radiation absorber and/or the wall section without substantial absorption of radiation by the device section.

In some preferred embodiments of the invention, the evacuation mechanism comprises a valve in fluid communication with the gas of the closed conduit section. The valve may form part of the device or, alternatively, the valve may form part of an external apparatus.

In some embodiments of the invention, the valve is in fluid communication with the gas of the closed conduit section via a passage comprised by a wall section of the closed conduit section.

In some preferred embodiments of the invention, the hole is created by a pointed object which is pressed against the wall section to create the hole. For example, the pointed object may penetrate the wall section to create the hole. In some embodiments, the pointed object is furthermore retracted after having penetrated the wall section. An advantage of such embodiments is that the invention can be performed by simple means and, if desired, without involving any electromechanical components.

The shape of the pointed object is preferably adapted to efficiently break or penetrate the wall section. While the presently preferred pointed object is a needle or a needle-like protrusion, other shapes such as pyramid-like protrusions can be used as well.

The pointed object may be located inside the micro conduit system or outside micro conduit system.

In some preferred embodiments of the invention, the evacuation mechanism comprises a seal which forms part of the wall of the closed conduit section, which seal is adapted to be torn off to evacuate the pressurized gas. An advantage of an evacuation mechanism comprising a seal is that the device can be controlled by direct user intervention. For example, the user may one or more seals as part of operating the device. Additionally, the seal forms part of the device and may be operated without any external evacuation mechanism or apparatus for liquid handling.

The seal may form part of the wall of the closed conduit section by covering a hole in a wall section. Alternatively, the seal may form part of the wall of the closed conduit section by constituting an entire wall section which is removed with the seal.

Normally, the seal is either be torn off manually during the use of the device or torn off automatically by an apparatus associated with the device.

In some preferred embodiments of the invention, the seal comprises or essentially consists of an adhesive tape.

For example, a sub-section of a device part, such as sub-section of a lid, may comprise said seal.

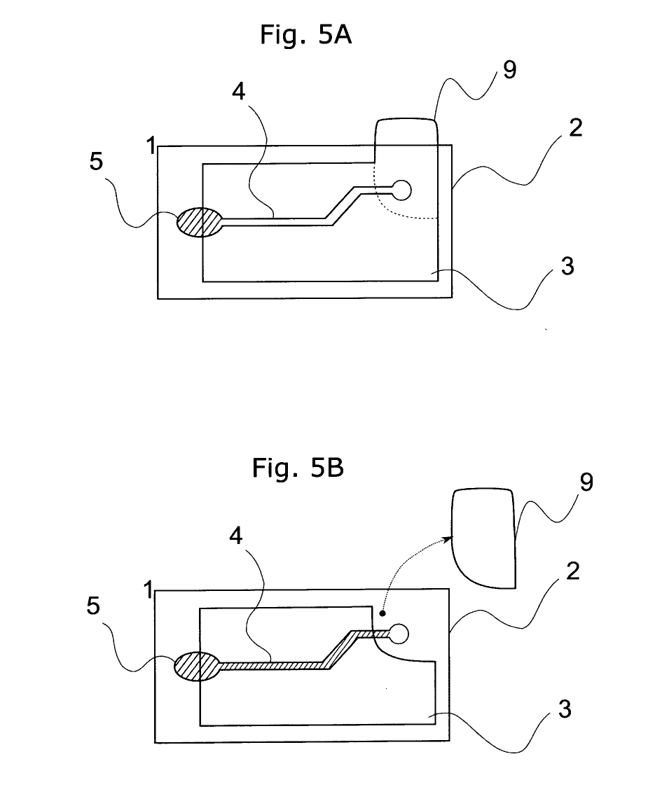

An exemplary embodiment of the invention, wherein the evacuation mechanism is a removable seal, is illustrated in FIG. 5A. Here a device (1) is shown having a base portion (2), micro conduit system (4) imprinted into the surface of the base portion (2) and a lid (3) attached to the base portion and enclosing the micro conduit system (4) including the closed conduit section. The seal (9) forms part of the lid (3) and can be torn off, either manually or automatically. The seal (9) also constitutes part of the wall of the closed conduit section, and once the seal is torn off, the gas evacuates from the closed conduit section and the liquid, shown as the hatching in the micro conduit system, enters the closed conduit section (see FIG. 5B). The liquid driving system of the device in FIGS. 5A-B is capillary forces between the first liquid and the micro conduit system.

In some preferred embodiments of the invention the smallest cross sectional dimension of the hole in the wall section is at least 5 micron, preferably at least 50 micron and even more preferred at least 100 micron, such as at least 250 micron, at least 500 micron or at least 1000 micron. For example, the smallest cross sectional dimension of the hole may be in the range of 5-5000 micron, such as 50-1000 micron, or 100-500 micron.

In the context of the present invention, the term “smallest cross sectional dimension” relates to the smallest dimension of the cross section, i.e. radius in case of a circular cross section. If the cross section is non-circular, the “smallest cross sectional dimension” is the diameter of the inscribed circle of the cross section, i.e. the diameter of the largest circle that could be contained within the cross section.

In some embodiments of the invention the gas of the closed conduit section contacts a gas blocking liquid, and activating the evacuation mechanism comprises moving the gas blocking liquid.

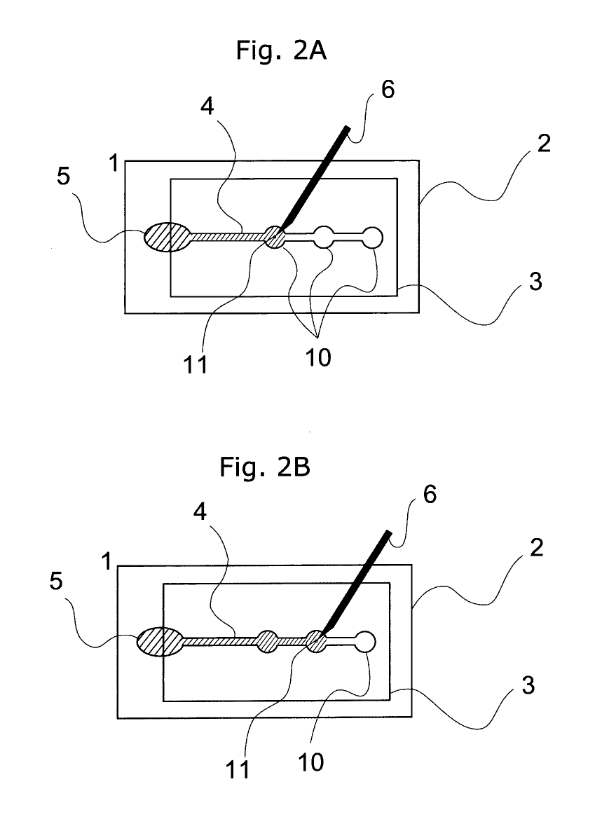

In preferred embodiments of the invention, at least two different types of evacuation mechanisms are used, e.g. a seal for evacuating a first closed conduit section and a pointed object to open a second closed conduit section. The invention also allows the use of more evacuation mechanism of the same type, e.g. a device comprising two or three seals to be removed sequentially, or breaking two or three wall sections using a pointed object (see. e. g. FIGS. 2A-b or FIG. 7).

In the context of the present invention, the term “micro conduit system” relates to one or more micro conduit components comprised by the device. Typical micro conduit components are micro channels, micro chambers, micro filters, micro cuvettes, micro mixers, micro pumps and/or micro valves. A micro conduit component typically has a smallest cross sectional dimension in the range of 0.1-1000 micron, preferably in the range 5-500 micron, and even more preferred in the range 10-250 micron.

In the context of the present invention, the phrase “Y and/or X” means “Y” or “X” or “Y and X”. Along the same line of logic, the phrase “n₁, n₂, . . . , nᵢ₋₁, and/or nᵢ” means “n₁” or “n₂” or . . . or “nᵢ₋₁” or “nᵢ” or any combination of the components: n₁, n₂, . . . nᵢ₋₁ and nᵢ.

When the micro conduit system contains more micro conduit components, these may be adjoined, and even in fluid communication, or they may be located separately.

In the context of the present invention, the term “inlet” relates to an opening or passage through which substances of interest can enter the micro conduit system. Substances of interest may for example be a liquid, e.g. a liquid sample, it may be a gas, it may be a solid, it may be a semi-solid, or it may be a suspension. The substance of interest may be substances like saliva, urine, feces, whole blood, serum, or plasma. The first liquid or any further liquids may be the substance of interest.

An inlet may be “always open”, i.e. is not closable as such and will stay open once the substance of interest has been applied. Alternatively an inlet may be a closable inlet which can be closed once the substance of interest has been applied.

In the context of the present invention, the term “conduit section” relates to a section of the micro conduit system which section comprises the first liquid and which section adjoins a closed conduit section.

In the context of the present invention, the term “closed conduit section” relates to a section of the micro conduit system which section comprises a gas, i.e. a gas bubble. Preferably, the closed conduit section adjoins the conduit section so that the gas contacts the first liquid, and so that the gas is enclosed within the closed conduit section.

While other gases may be used, the gas typically either comprises or essentially consists of atmospheric air.

The micro conduit system may comprise at least one micro channel. The micro conduit system may comprise at least one micro chamber. The micro conduit system may comprise at least one filter. The micro conduit system may comprise at least one electrode and preferably a pair of electrodes.

In some preferred embodiments of the invention the micro conduit system furthermore comprises at least one hydrophobic section.

In the context of the present invention, the term “hydrophobic section” relates to a section of the micro conduit system, in which the surface is hydrophobic.

A surface is hydrophobic if the contact angle between a drop of demineralised water and the surface is more than 90 degrees. The contact angle is determined as the angle, measured inside the drop of demineralised water, between the surface-water interface and the water-air interface.

It is preferred that the at least one hydrophobic section forms part of the closed conduit section.

The at least one hydrophobic section may be a hydrophobic valve, i.e. a hydrophobic conduit section located between a first and a second hydrophilic conduit section. A hydrophobic valve will stop a hydrophilic liquid, which normally will be unable to enter the hydrophobic conduit section. The hydrophobic valve can withstand liquid pressure up to a certain pressure threshold. Once the pressure of the liquid exceeds the pressure threshold, the hydrophilic liquid enters the hydrophobic conduit section and contacts the second hydrophilic conduit section, whereby the hydrophobic valve loses its ability to stop the liquid flow.

In some embodiments of the invention, the micro conduit system furthermore comprises at least one gas retarding element. A gas retarding element slows down the evacuation of the pressurized gas, and consequently also slows down the introduction of the first liquid into the closed conduit section. This is useful when physical or chemical interactions require some reaction time, e.g. when nucleic acids or antigens of a liquid sample should be captured by immobilized reagents in the micro conduit system, or when a dried reagent of the surface of micro conduit system should be dissolved by a liquid contacting the dried reagent. The at least one gas retarding element preferably forms part of the closed conduit section.

The gas retarding element retards or restricts the flow of the gas during the evacuation of the gas and may e.g. comprise a micro channel having a narrow cross section or a narrow passage and/or a micro channel having a relatively long length. Useful gas retarding elements typically have smallest cross sectional dimensions in the range of 5-20 μm and/or a length in the range of 10-100 mm.

The hole in the wall section may also be a gas retarding element, in which case the smallest cross sectional dimension of the hole typically is at most 100 micron, preferably at most 25 micron, and even more preferred at most 10 micron, such as at most 5 micron.

In some preferred embodiments of the invention the conduit section comprises or essentially consists of a micro channel, and typically of two or more adjoining micro channels.

For example, the closed conduit section may comprise or essentially consist of a micro channel.

The micro channels may have a number of different cross sectional shapes, e.g. substantially rectangular, substantially circular, or substantially triangular.

The micro conduit system may comprise at least one meander-like micro channel and/or it may comprise at least one spiral like micro channel.

When the method of the invention is used for liquid handling as part of a chemical analysis, the micro conduit system usually contains a reagent and frequently two or more reagents.

In some preferred embodiments of the invention the micro conduit system comprises at least one immobilized reagent. The immobilized reagent may comprise one more reagents selected from the group consisting of an antigen, an epitope, an enzyme, a nucleic acid, an antibody, a receptor, a peptide, a protein, a protein fragment, a liposome, a cell, a cell organelle, and combinations thereof.

The term “nucleic acid” should be interpreted broadly and encompasses e.g. DNA and RNA, synthetic nucleic acids like LNA and PNA, double stranded nucleic acids and single stranded nucleic acids, and derivatives thereof.

In some preferred embodiments of the invention the micro conduit system furthermore comprises at least one dried reagent. The dried reagent may comprise one more reagents selected from the group consisting of an antigen, an epitope, an enzyme, a nucleic acid, an antibody, a receptor, a peptide, a protein, a protein fragment, a liposome, a cell, a cell organelle, a salt, an dNTP, and a pH-buffer salt. The dried reagent may also comprise e.g. particles, nanotubes, nanoballs, or nanoshells.

The micro conduit system may contain a plurality of reagents, such as at least two, three or four reagents. These reagents may be selected among the reagents mentioned herein.

In some preferred embodiments of the invention the micro conduit system comprises at least some of reagents for performing a Polymerase Chain Reaction (PCR) process and preferably the micro conduit system comprises all the reagents.

The micro conduit system may comprise polymerase enzyme such as a DNA polymerase. The micro conduit system may comprise a salt such as MgCl₂. The micro conduit system may comprise dNTPs, i.e. the nucleotides for performing the PCR process. The micro conduit system may comprise the nucleic acid primers. The micro conduit system may comprise the polymerase, the MgCl₂, the dNTPs and the PCR primers.

In some preferred embodiments of the invention at least a portion of the surface of the micro conduit system comprises a salt. The salt may e.g. be a pH buffer salt. Examples of useful salts are MgCl₂, NH₄Cl, NaCl, KCl, TB (Tris-Borate), TBE (Tris-Borate-EDTA), or Tris. These may be used alone or in combination.

When the liquid driving system has to involve flow due to capillary forces, and particularly when the native surface of the micro conduit system is hydrophobic and the first liquid is hydrophilic, it may be advantageous to have one or more salts on the surfaces of the micro conduit system, which surfaces are to contact the first liquid.

In some embodiments of the invention the micro conduit system comprises at least two closed conduit sections, such as at least three closed conduit sections.

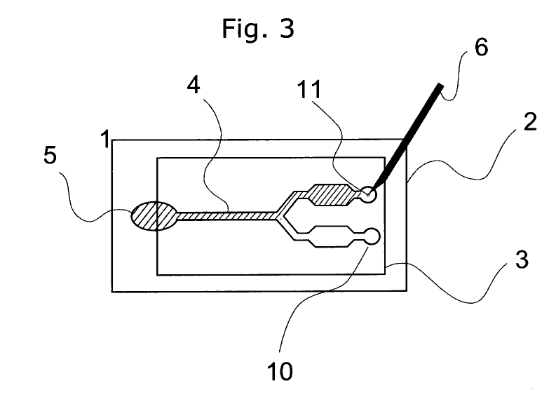

The at least two closed conduit sections may be located separately in the device. Alternatively the at least two closed conduit sections may be in fluid communication. An example of this is shown in FIG. 3. The device (1) comprises a bifurcated micro conduit system (4). The first liquid (represented by the hatching) fluid may be directed along different flow paths by activating the evacuation mechanisms at different points (10). One evacuation mechanism has been activated and the first liquid has been allowed to fill the upper depicted volume along the upper branch of the bifurcation. The lower evacuation mechanism may be activated at a later stage.

Alternatively the second closed conduit section of the at least two closed conduit sections may be a sub-part of the first closed conduit section. An exemplary embodiment of this shown in FIG. 2A, where the device (1) comprises a number of points for pressure evacuation (10). The first evacuation mechanism has been activated by pressing the pointed object (6) against the point for pressure evacuation (10), thereby creating a hole (11). Consequently, the first liquid has moved from the inlet (5) to said point (10). The hatching represents the first liquid. In FIG. 2B, the next evacuation mechanism has been activated. This has allowed the first liquid to enter the second closed conduit section, which was a sub-part of the first closed conduit section. The device (1) of FIGS. 2A-B contain a third point for pressure evacuation (10), and therefore it also contains a third closed conduit section, which is a sub-part of both the first and second closed conduit section. The liquid driving system of the device in FIGS. 2A-B is capillary forces between the first liquid and the micro conduit system.

The second closed conduit section of the at least two closed conduit sections may alternatively be an extension of the first closed conduit section, e.g. by being located next to the first closed conduit section but being separated from it by means of a separation wall. Once gas from the first closed conduit section has been evacuated and the first liquid has entered the first closed conduit section, the separation wall may be removed or opened to form a second closed conduit section. Removal of the separation wall may be accomplished by the same mechanisms that may be used for creating a hole in the wall section of the closed conduit section.

In some embodiments of the invention the device comprises at least one closed conduit section which is not:
a first closed conduit section located next to a second closed conduit section but separated from the second closed conduit section by means of a separation wall.

In some embodiments of the invention the device comprises at least one closed conduit section, which is not:
located adjacent to a chamber and separated from said chamber by a separation wall.

In some preferred embodiments of the invention the evacuation of step c) introduces the first liquid into the first closed conduit section, but not into the second closed conduit section, which is either a sub-part or an extension of the first closed conduit section, and which still contains gas, the method furthermore comprising the steps
d) providing a liquid driving system pressing the first liquid against the gas, thus pressurizing the gas, and
e) activating a second evacuation mechanism, thereby allowing at least a portion of the pressurized gas of the second closed conduit section to evacuate, and thereby allowing the liquid driving system to introduce the first liquid into the second closed conduit section

The liquid driving system may be the same as in step b) or it may be a different liquid driving system.

In the context of the present invention, the term “first liquid” relates to any sort of liquid which can be moved through a micro conduit system. In some preferred embodiments of the invention the first liquid is an aqueous liquid. In some embodiments of the invention the first liquid is introduced via the at least one inlet. In other embodiments of the invention the first liquid is contained in a reservoir of the device prior to the use of the device.

The micro conduit system may furthermore comprise a second liquid. The second liquid may be contained in a reservoir of the device prior to the use of the device or it may be introduced via an inlet to the micro conduit system.

For example, the second liquid may be introduced via the inlet of the micro conduit system and the first liquid, prior to the use of device, is contained by a reservoir comprised by the device.

It is also possible that the second liquid is introduced via the same inlet of the micro conduit system as the first liquid. Alternatively, the first liquid is introduced via a first inlet and the second liquid is introduced via a second inlet.

The second liquid may introduced after step c), i.e. after activating the evacuation mechanism. Alternatively, the second liquid may be introduced before step c) or even during step c).

The liquid driving system is responsible for the movement of the liquid through the micro conduit system.

In some preferred embodiments of the invention the liquid driving system comprises capillary forces affecting the first liquid. The capillary forces preferably comprise the capillary forces of the micro conduit system of the device, i.e. capillary forces between the surface of the micro conduit system and the first liquid. An advantage of flow due to capillary forces is that no external liquid driving system is necessary. This makes the method and the device of the invention simpler, cheaper and more robust than prior art systems.

For example, the capillary forces may comprise the capillary forces of the conduit section of the micro conduit system, i.e. capillary forces between the surface of the conduit section and the first liquid.

In an embodiment of the invention, the micro conduit system comprises a capillary force enhancing element to increase the capillary forces acting on the first liquid or a further liquid. Useful examples of capillary force enhancing element are e.g. found in WO 98/43,739, which is incorporated herein by reference for all purposes.

A useful capillary force enhancing element is e.g. a capillary fibre structure such as e.g. a filter paper or a woven member; another capillary force enhancing element is a membrane or a porous solid or a gel such as e.g. a silica gel.

Other examples of useful capillary force enhancing elements are nano-grooves and/or a plurality of nano-pillars. The nano-grooves are nano-scale grooves formed in the surface of the micro conduit system. The nano-grooves increase the effective surface area of the micro conduit system and thereby increase the capillary force acting on the first liquid. Nano-grooves may e.g. be prepared mechanically by gentle grinding of the surface of the micro conduit system or by hot-embossing or micro-injection moulding.

The plurality of nano-pillars also increase the effective surface area of the micro conduit system and therefore increase the capillary forces. An example of useful nano-pillars (micro posts) are found in WO 03/103,835 which is incorporated herein by reference. Preferably, the nano-pillars have cross sectional dimensions of at most 1000 nm.

Alternatively or additionally, the capillary forces may comprise the capillary forces of a portion of the closed conduit section of the micro conduit system.

The micro fluidic conduit of the present invention may comprise one or more of the time gate(s) mentioned in WO 98/43,739.

The micro fluidic conduit of the present invention may comprise one or more of the flow control element(s) of WO 98/43,739.

In some embodiments of the invention the liquid driving system comprises an external pressure on the first liquid.

In some embodiments of the invention the liquid driving system comprises thermal expansion of a component.

In some embodiments of the invention the liquid driving system comprises an external pump. Alternatively or additionally, the liquid driving system may comprise a pump comprised by the device.

In other embodiments of the invention the liquid driving system comprises a compressed driving gas acting on the first liquid.

In further embodiments of the invention the liquid driving system comprises gravitational forces acting on the first liquid.

In still further embodiments of the invention the liquid driving system comprises centrifugal forces acting on the first liquid.

When the method involves the use of several liquids, these may be moved by the same liquid driving system or by different liquid driving systems. It is also possible to have the same liquid moved by two or more different liquid driving systems.

The method and the device of the invention are particularly useful for chemical or biological analysis.

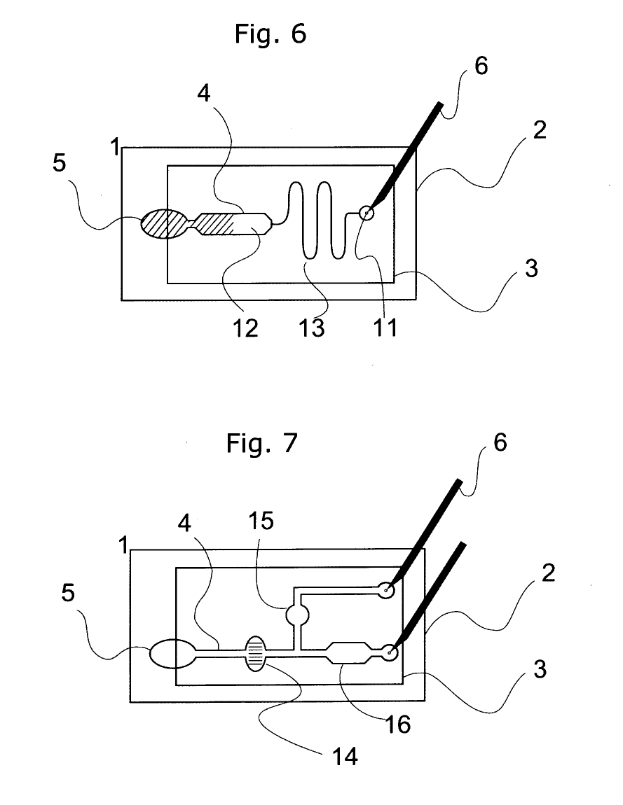

An exemplary embodiment of a device and method for biochemical analysis is shown in FIG. 6. The device (1) comprises a gas retarding element (13) in the form of a narrow micro channel, which exerts substantially constant resistance to the gas that is evacuated from biochemical reactor (12). The biochemical reactor may contain immobilized reagents for capturing target molecules from first liquid (represented by the hatching), and these reagents typically benefit from longer contact time with the first liquid. The liquid driving system of the device in FIG. 6 is capillary forces between the first liquid and the micro conduit system.

An exemplary embodiment of a device and method for PCR amplification is shown in FIG. 7. The device (1) contains the components of a biochemical analysis system for analysing cellular matter of a liquid sample. The liquid sample is applied to the inlet (5) and is moved into the conduit section by capillary forces. When the lower pressure evacuation mechanism is activated, the liquid sample is allowed to pass through a cell filter (14) and to enter a waste reservoir (16). The trapped cells are lysed by applying ultrasound to the cell-filter (14), thus obtaining a cell lysate. When the upper pressure evacuation mechanism is activated, the cell lysate is moved to the PCR reaction chamber (15) which contains the relevant PCR reagents, and a PCR amplification is performed including real-time measurement by means of TAQman™ probes and fluorescence detection.

The device may comprise other analysis components such as micro arrays, capillary electrophoresis channels and reservoirs and the method may include steps of operating these analysis components.

A further aspect of the invention relates to a device as described herein.

Yet an aspect of the invention relates to a system comprising an apparatus as described herein and a device as described herein. The apparatus may contain one or more components which form part of the evacuation mechanism. Such components could e.g. be one or more pointed objects and/or a laser. The apparatus may also comprise one or more liquid driving systems such as one or more pressure or vacuum pumps, a centrifugal spindle or similar.

The apparatus may additionally comprise one or more sensors components for detecting the outcome of said chemical reactions. Examples of useful sensor components are e.g. lasers and/or light emitting diodes, photodiodes, optical filter systems, photomultiplier tubes, CCD/CMOS cameras.

The apparatus may also comprise components such as a display and/or a computer.

The present invention has been described above with reference to specific embodiments. However, other embodiments than the above described are equally possible within the scope of the invention. The different features and steps of various embodiments and aspects of the invention may be combined in other combinations than those described herein.

1. A method of controlling a liquid flow, the method comprising the steps of:
a) providing a device (1) comprising a micro conduit system (4), the micro conduit system (4) comprising
at least one inlet (5),
a conduit section containing a first liquid, and
a closed conduit section adjoining the conduit section, said closed conduit section containing a gas, said gas contacting the first liquid of the conduit section, and
b) providing a liquid driving system pressing the first liquid against the gas, thus pressurizing the gas, and
c) activating an evacuation mechanism, thereby allowing at least a portion of the pressurized gas of the closed conduit section to evacuate, and thereby allowing the liquid driving system to introduce the first liquid into the closed conduit section.

2. The method according to claim 1, wherein the first liquid of step a) is provided by applying said first liquid to the inlet (5) and moving it to the conduit section using the liquid driving means.

3. The method according to claim 1, wherein activating the evacuation mechanism comprises creating a hole (11) in a wall section of the closed conduit section, said hole (11) allowing at least a portion of the pressurized gas to leave the closed conduit section.

4. The method according to claim 3, wherein the hole (11) is created by heating a portion of said wall section.

5. The method according to claim 4, wherein said heating at least partly is provided by a heating element.

6. The method according to claim 4, wherein said heating comprises absorption of electromagnetic radiation by said wall section or by a part of the device (1) adjacent to said wall section.

7. The method according to claim 3, wherein the hole (11) is created by ablating a portion of said wall section using electromagnetic radiation.

8. The method according to claim 6, wherein the electromagnetic radiation is provided by a laser.

9. The method according to claim 6, wherein the device (1) comprises a radiation absorber, and wherein at least a portion of said electromagnetic radiation is absorbed by said radiation absorber.

10. The method according to claim 9, wherein the wall section to be addressed by electromagnetic radiation comprises the radiation absorber.

11. The method according to claim 9, wherein the radiation absorber is located adjacent to the wall section.

12. The method according to claim 8, wherein the device (1) comprises a translucent device section located adjacent to the radiation absorber, said device section allowing the electromagnetic radiation to reach the radiation absorber and/or the wall section without substantial absorption of radiation by the device section.

13-22. (canceled)

23. The method according to claim 1, wherein the evacuation mechanism comprises a seal (9) which forms part of the wall of the closed conduit section, which seal (9) is adapted to be torn off to evacuate the pressurized gas.

24. The method according to claim 23, wherein the seal (9) comprises or essentially consists of an adhesive tape.

25. The method according to claim 23, wherein a sub-section of a device part, such as e.g. a lid (3) or a substantial wall part component, comprises said seal (9).

26. (canceled)

27. The method according to claim 1, wherein the gas of the closed conduit section contacts a gas blocking liquid, and wherein activating the evacuation mechanism comprises moving the gas blocking liquid.

28-32. (canceled)

33. The method according to claim 1, wherein the micro conduit system (4) furthermore comprises at least one hydrophobic section.

34. The method according to claim 33, wherein the at least one hydrophobic section forms part of the closed conduit section.

35. The method according to claim 33, wherein the at least one hydrophobic section is a hydrophobic valve.

36. The method according to claim 1, wherein the micro conduit system (4) furthermore comprises at least one gas retarding element.

37. The method according to claim 3, wherein the at least one gas retarding element forms part of the closed conduit section.

38. The method according to claim 1, wherein the conduit section comprises or essentially consists of a micro channel.

39. The method according to claim 1, wherein the closed conduit section comprises or essentially consists of a micro channel.

40. The method according to claim 1, wherein the micro conduit system (4) furthermore comprises at least one meander-like micro channel.

41-74. (canceled)
